(19) United States
(12) Patent Application Publication
(10) Pub. No.: US 2020/0168001 A1
(43) Pub. Date: May 28, 2020

(54) DISPLAY UNIT FOR AR/VR/MR SYSTEMS

(71) Applicant: RAONTECH, Inc., Seongnam-si (KR)

(72) Inventors: Worldong Yang, Seongnam-si (KR); Kwang Won Kim, Seongnam-si (KR); Wook Hong, Gangwon-do (KR); Saejin Park, Seoul (KR)

(21) Appl. No.: 16/360,540

(22) Filed: Mar. 21, 2019

(30) Foreign Application Priority Data
Nov. 28, 2018 (KR) 1020180149533

(51) Int. Cl. G06T 19/00; G09G 5/00; G06K 9/00

(52) U.S. Cl. CPC G06T 19/006; G09G 5/001; G06K 9/00671; G09G 5/006

(57) ABSTRACT

A display unit may be provided, and more particularly a display unit for AR/VR/MR systems, which is capable of reducing MTP latency, may be provided. The display unit includes: a display controller which includes a frame buffer which stores a rendered frame received from a renderer, a display time warp engine which outputs a time warp control signal on the basis of sensing information received from a motion detection and position tracking system, and a refresher which reads the frame stored in the frame buffer and time-warps the frame on the basis of the time warp control signal; and a display panel which is provided with time-warped frame by the refresher and displays the frame on a screen thereof.

### BACKGROUND

### Field

The present disclosure relates to a display unit and more particularly to a display unit for AR/VR/MR systems, which is capable of reducing motion to photon (MTP) latency.

### Description of the Related Art

In the use of a head mounted display (HMD) by a user in an augmented reality (AR) system, a virtual reality (VR) system, and a mixed reality (MR) system, when the user moves his/her position or turns his/her head, information required for the movement is obtained from an inertial measurement unit (IMU), Optic Engine, or the like. After the obtained information is transmitted to the system of AP (Application Processor), a final GPU regenerates an image corresponding to the turning and the regenerated image is transmitted to the display unit of the HMD. During such a process, motion to photon (MTP) latency occurs, which causes the user using the HMD to feel heterogeneity due to the discrepancy between reality and virtual reality.

The MTP latency refers to time from a moment when the user starts to move to a moment when the movement is reflected on an actual and photons reach the eyes of the user. That is to say, the MTP latency means a time interval that occurs between the sight movement of the user and screen update. Reduction of the MTP latency is a critical factor in providing AR, VR, and MR use environments.

Conventional HW time warp or SW time warp is performed in a system area located in the front of a display unit. Therefore, during final transmission of updated images to the display unit, the MTP latency occurs again.

Hereinafter, the conventional AR/VR/MR systems will be schematically described with reference to FIGS. 1 to 5.

FIG. 1 shows a first example of the conventional AR/VR/MR systems and shows display MTP latency in the conventional AR/VR/MR systems according to the first example. FIG. 2 shows a second example of the conventional AR/VR/MR systems and shows display MTP latency in the AR/VR/MR systems which support Tethered. FIG. 3 shows a third example of the conventional AR/VR/MR systems of FIG. 2 and shows display MTP latency in the AR/VR/MR systems which support Time Warp by a hardware method or a software method. FIG. 4 shows a fourth example of the conventional AR/VR/MR systems and shows display MTP latency in the AR/VR/MR systems which support image compression and Time Warp.

Referring to FIGS. 1 to 4, in the conventional AR/VR/MR systems according to the first example shown in FIG. 1, the MTP latency occurs from a first time point (t0) to a fourth time point (t4). In the conventional AR/VR/MR systems according to the second example shown in FIG. 2, the MTP latency occurs from the first time point (t0) to a fifth time point (t5). In the conventional AR/VR/MR systems according to the third example shown in FIG. 3, the MTP latency occurs from the second time point (t2) to the fourth time point (t4). In the conventional AR/VR/MR systems according to the fourth example shown in FIG. 4, the MTP latency occurs from the second time point (t2) to the fourth time point (t4).

Meanwhile, a sequential display panel, for example, Liquid Crystal on Silicon (LCoS) and Digital Light Processing (DDP), which supports Wave Guide Optic such as Holographic Optical Element (OE) and Diffractive Optical Element (DOE), has a structure which scans R, G, and B fields respectively. Therefore, when the user using the HMD moves quickly, R, G, and B images may be displayed on different areas respectively. As a result, color breakup may occur. The occurrence of the color breakup makes the user using AR/VR/MR devices feel inconvenient.

Also, as shown in FIG. 5, a display driver IC (DDI) that is a controller which controls the conventional sequential display panel such as Liquid Crystal on Silicon (LCoS) and Digital Light Processing (DDP) had to convert an application processor (AP) (or an R/G/B bit packed pixel stream(e.g., R/G/B 24 BITs)) which is provided from a graphic processor unit (GPU) into an R/G/B field stream and provide to the sequential display panel. Therefore, the display driver IC had to have a double or more buffer in order to convert the R/G/B bit packed pixel stream into the R/G/B field stream. The double or more buffer increases the size of a memory to be supported by the display driver IC and causes the MTP latency of at least 1 frame or more.

### SUMMARY

One embodiment is a display unit including: a display controller which includes a frame buffer which stores a rendered frame received from a renderer, a display time warp engine which outputs a time warp control signal on the basis of sensing information received from a motion detection and position tracking system, and a refresher which reads the frame stored in the frame buffer and time-warps the frame on the basis of the time warp control signal; and a display panel which is provided with the time-warped frame by the refresher and displays the frame on a screen thereof.

### BRIEF DESCRIPTION OF THE DRAWINGS

FIG. 1 shows a first example of the conventional AR/VR/MR systems and shows display MTP latency in the conventional AR/VR/MR systems according to the first example:

FIG. 2 shows a second example of the conventional AR/VR/MR systems and shows display MTP latency in the AR/VR/MR systems which support Tethered;

FIG. 3 shows a third example of the conventional AR/VR/MR systems of FIG. 2 and shows display MTP latency in the AR/VR/MR systems which support Time Warp by a hardware method or a software method;

FIG. 4 shows a fourth example of the conventional AR/VR/MR systems and shows display MTP latency in the AR/VR/MR systems which support image compression and Time Warp;

FIG. 5 shows structures of an R, G, B bit packed pixel stream and an R, G, B field stream in the conventional AR/VR/MR systems;

FIG. 6 is a block diagram showing a display unit and AR/VR/MR systems including the display unit according to an embodiment of the present invention;

FIG. 7 is a view for describing a display unit 500′ and AR/VR/MR systems including the display unit according to another embodiment of the present invention;

FIG. 8 is a view for describing a display unit 500″ and AR/VR/MR systems including the display unit according to further another embodiment of the present invention;

FIG. 9 is a view for describing a display unit 500″ and AR/VR/MR systems including the display unit according to yet another embodiment of the present invention; and

FIG. 10 shows recognition of a user who wears the display unit 500″ according to still another embodiment of the present invention when the display unit 500″ and the AR/VR/MR systems including the display unit 500″ according to the further another embodiment of the present invention shown in FIG. 9 are applied.

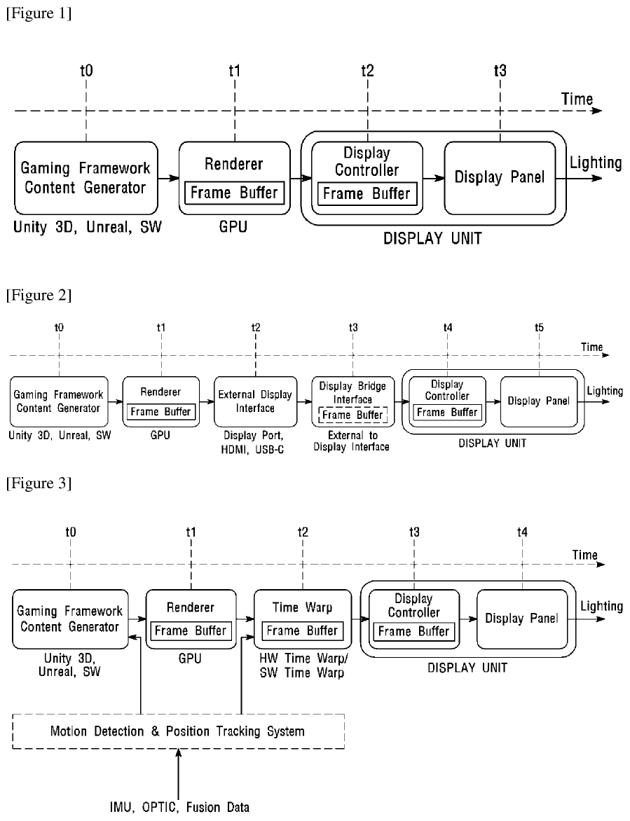

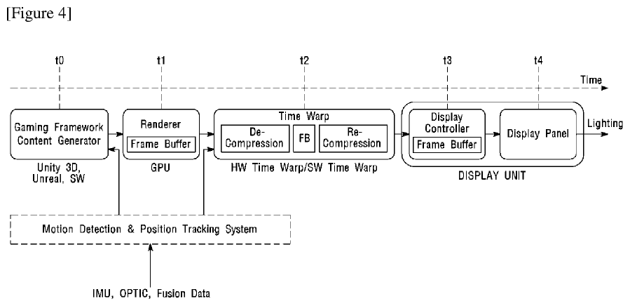

### DETAILED DESCRIPTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

FIG. 6 is a block diagram showing a display unit and AR/VR/MR systems including the display unit according to an embodiment of the present invention.

FIG. 6 also shows illustratively display motion to photon (MTP) latency in the AR/VR/MR systems including the display unit according to the embodiment of the present invention.

Referring to FIG. 6, the AR/VR/MR systems may include a content generator 100, a renderer 300, a display unit 500, and a motion detection and position tracking system 700.

The content generator 100 generates a predetermined content. The predetermined content may be still images, videos, 3D images, stereoscopic images, etc. The content generator 100 may be unity3D engine or Unreal engine which is capable of developing games for AR, VR, and MR. Also, the content generator 100 may be software (SW) which generates a predetermined content.

The predetermined content generated by the content generator 100 may be composed of a plurality of frames and displayed on the screen in the display unit 500. Here, the frame refers to a piece of a still image displayed on the screen of a display panel 550 of the display unit 500. Also, the frame is used to indicate how many still images are displayed on one screen in a video game and is also used as a unit for indicating how many motions per second are captured in a motion capture system.

The renderer 300 receives the content from the content generator 100 and renders the received content, so that rendered frame (or rendered image information)is generated.

The renderer 300 may generate the rendered frame by changing the shadow, color, and concentration of the frame of the received content. Here, rendering is a computer graphics terminology which means a process of generating a 3D image by infusing realism into a 2D image in consideration of external information such as light source, position, color, etc. The rendering method includes a wire frame rendering method, a raytracing rendering method, etc.

The renderer 300 may render the frame such that the frame is displayed at a rate the same as a refresh rate, for example, 30 frames per second, of the display unit 500.

The renderer 300 may be a graphics processing unit and may include a frame buffer 350 which stores data of the rendered frame.

The frame buffer 350 stores the frame displayed on the screen of the display panel 550 on each pixel basis. For example, when monochrome information is output, one bit is caused to correspond to one pixel and black and white are distinguished according to the bit value. A color image is represented by causing various bits to correspond to one pixel. The frame buffer 350 can be implemented by a memory such as SDRAM.

The motion detection and position tracking system 700 measures an inertial amount of a moving object and can sense the movement direction, current pose, current position, etc., of the object. The motion detection and position tracking system 700 may include an IMU sensor module. Also, the motion detection and position tracking system 700 may also include an optical-based sensor.

Further, the motion detection and position tracking system 700 may include a plurality of sensors and may generate and output sensor fusion data by fusing sensing signals output from the plurality of sensors.

Sensing information sensed by the motion detection and position tracking system 700 may be provided to a display time warp engine 515 of a display controller 510. The sensing information sensed by the motion detection and position tracking system 700 is provided to the content generator 100. The content generator 100 may generate a predetermined content on the basis of the sensing information. Here, the sensing information may include, for example, orientation information, position information, etc.

The display unit 500 includes the display controller 510 and the display panel 550.

The rendered frame generated by the renderer 300 is read by the display controller 510 and is provided to the display panel 550. Here, the display controller 510 may time-warp the rendered frame in accordance with the sensing information provided from the motion detection and position tracking system 700 and may provide the time-warped frame to the display panel 550.

The display controller 510 operates such that a frame suitable for viewing of a user who wears the display unit 500 is provided to the display panel 550. The display controller 510 may be connected in a wired or wireless manner to the display panel 550.

The display controller 510 may be a display driver IC (DDI). The DDI is a small semiconductor chip which is used to drive each pixel of the display panel 550 such as OLED, LCD, etc.

The display controller 510 may receive information of the rendered frame stored in the frame buffer 350 of the renderer 300.

The display controller 510 may include a frame buffer 511.

The frame buffer 511 reads the rendered frame from the renderer 300 and stores it in the form of data. The frame buffer 511 stores the data of the frame displayed on the screen of the display panel 550 on each pixel basis.

The frame buffer 511 can be implemented by a memory such as SDRAM

The display controller 510 may include a refresher 513.

The refresher 513 reads the data of the rendered frame stored in the frame buffer 511 and time-warps the rendered frame data on the basis of a time warp control signal provided from the display time warp engine 515. Then, the refresher 513 provides the time-warped frame data to the display panel 550.

The refresher 513 may refresh the frame buffer 511 periodically in order to prevent the loss of rendered frame data stored in the frame buffer 511. The periodic refresh time is referred to as refresh time.

The display controller 510 may include the display time warp engine 515.

The display time warp engine 515 receives sensing information including motion and position information from the motion detection and position tracking system 700.

The display time warp engine 515 generates the time warp control signal on the basis of the received sensing information and provides the generated time warp control signal to the refresher 513. The time warp control signal includes movement information of each pixel of the frame stored in the frame buffer 511.

The refresher 513 may correct data information (bit string) of each pixel of the rendered frame read from the frame buffer 511 on the basis of the time warp control signal including the movement information of each pixel. Hence, the display panel 550 may display the frame which is corrected according to the motion or/and movement of the user.

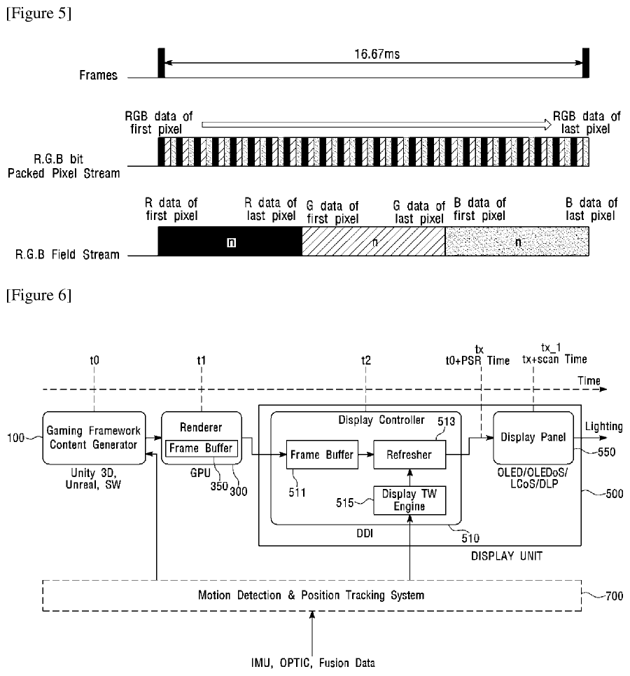

In the AR/VR/MR systems according to the embodiment of the present invention shown in FIG. 6, the time-warp is performed in the display controller 510 within the display unit 500 without being performed in the step before the display unit 500. Therefore, motion to photon (MTP) latency is nothing but a time tx_1 obtained by sum of a time tx for which the refresher 513 reads the data of the frame stored in the frame buffer 511 and a scan time of the display panel 550. Therefore, compared with the systems of FIGS. 3 and 5 which perform the time-warp in the step before the display unit 500, the AR/VR/MR systems have an advantage that the MTP latency is significantly reduced.

The display panel 550 can be implemented by a liquid crystal display (LCD), a field emission display (FED), a plasma display panel (PDP), an electroluminescence device (EL) including an inorganic electroluminescent device and an organic light emitting diode (OLED), OLED on Silicon (OLEDoS), LCoS using liquid crystal, and a display panel of a flat panel display such as an electrophoresis display (EPD), etc.

In the display panel 550, data lines and scan lines (or gate lines) gross each other. The display panel 550 includes pixels which are formed in the form of a matrix defined by the data lines and scan lines. Each pixel of the display panel 550 may include a plurality of subpixels (red subpixels, green subpixels, blue subpixels). Each subpixel may include a thin film transistor (TFT).

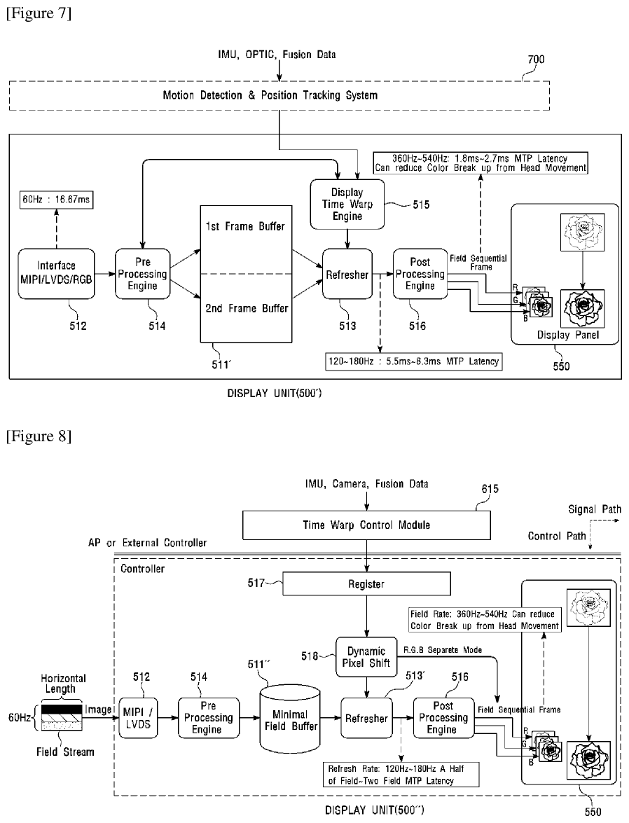

FIG. 7 is a view for describing a display unit 500′ and AR/VR/MR systems including the display unit 500′ according to another embodiment of the present invention.

Although only the display unit 500′ and the motion detection and position tracking system 700 are shown in FIG. 7, the entire display system play further include the content generator 100 and the renderer 300 shown in FIG. 6. In this case, the content generator 100 and the renderer 300 shown in FIG. 6 may be disposed in front of the display unit 500′ shown in FIG. 7.

The display unit 500′ shown in FIG. 7 may include an interface 512 which receives the rendered frame (or image) from the renderer 300 shown in FIG. 6, a preprocessing engine 514 which preprocesses the rendered frame provided from the interface 512, a frame buffer 511′ which stores the preprocessed frame, the refresher 513, the display time warp engine 515, a post-processing engine 516, and the display panel 550. Here, the interface 512, the preprocessing engine 514, the frame buffer 511′, the display time warp engine 515, and the post-processing engine 516 may be included in the display controller.

The interface 512 serves to connect the display unit 500′ and a part such as the renderer 300 to allow them to trans it/receive the data of the rendered frame. For example, the interface 512 may be one of DSI interface of Mobile Industry Processor Interface (MIPI), Low Voltage Differential Signal (LVDS) interface, and RG-B interface.

The preprocessing engine 514 preprocesses the frame provided through the interface 512. Here, during the preprocessing, the provided frame may be decompressed or bypassed, or motion estimation is performed to estimate which position in the second frame each pixel of the first frame of the frames received earlier and later has moved to. The decompression, bypass, and motion estimation may be all performed by the preprocessing engine 514, or at least one or combined two of the decompression, bypass, and motion estimation may be performed by the preprocessing engine 514.

The preprocessing engine 514 may provide preprocessing information of the preprocessed frame to the display time warp engine 515. Here, the preprocessing engine 514 may provide preprocessing information according to the request of the display time warp engine 515 to the display time warp engine 515. Here, the preprocessing information may include comparison information of the frames received earlier and later. The display time warp engine 515 may determine whether to time-warp the frame on the basis of the provided comparison information and the sensing information provided from the motion detection and position tracking system 700.

Unlike the frame buffer 511 shown in FIG. 5, the frame buffer 511′ may be composed of a double frame buffer. That is, the frame buffer 511′ includes a first frame buffer and a second frame buffer. Since the frame buffer 511′ including the first frame buffer and the second frame buffer is able to store the frames received earlier and later with a time interval, display processing can be stably performed at a high speed. Particularly, in the AR/VR/MR systems, virtual images and 3D images or reality images instead of simple 2D images are mixed, and data of corresponding image information has a large size. Therefore, by using the double frame buffer, the processing can be stably performed at a high speed.

The refresher 513 can increase a frame rate. For example, the refresher 513 can increase the frame rate to a frame rate (120 Hz to 180 Hz) higher than the frame rate (60 Hz) of the frame that is input through the interface 512. A method for increasing the frame rate is to generate and insert an intermediate frame between the frames received earlier and later by frame rate up conversion. By increasing the frame rate, the MTP latency can be further reduced.

When the display panel 550 is a sequential display panel which scans R, G, and B respectively, the refresher 513 may re-adjust the pixel position of ach of an R field, a G field, and a B field which are transmitted to the display panel 550, on the basis of the time warp control signal from the display time warp engine 515. By the readjustment of the refresher 513, it is possible to reduce color breakup of an image being scanned on the screen of the display panel 550 due to the motion of the user.

FIG. 8 is a view for describing a display unit 500″ and AR/VR/MR systems including the display unit according to further another embodiment of the present invention.

The display unit 500″ shown in FIG. 8 may include the interface 512 which receives the rendered frame from the renderer 300 shown in FIG. 6, the preprocessing engine 514 which preprocesses the rendered frame provided from the interface 512, a field buffer 511″ which stores the preprocessed frame, the refresher 513′, the post-processing engine 516, a register 517, a dynamic pixel shifter 518, and the sequential display panel 550. Here, the interface 512, the preprocessing engine 514, the field buffer 511″, the refresher 513′, the post-processing engine 516, the resister 517, and the dynamic pixel shifter 518 may be included in the display controller, for example, the display driver IC (DDI), which controls the display panel 500.

The interface 512 serves to connect the renderer 300 and the display unit 500″ to allow them to transmit/receive information of one or multiple frames. For example, the interface 512 may be one of DSI interface of Mobile Industry Processor Interface (MIPI) or Low Voltage Differential Signal (LVDS) interface.

The interface 512 receives information of one or multiple frames from the renderer 300 shown in FIG. 6. The received information of each frame is not an R/G/B bit packed pixel stream shown in FIG. 5 but an R/G/B field stream for the sequential display panel 550. In other words, the interface 512 receives the R/G/B field stream shown in FIG. 5 as the information of each frame from the renderer 300. For this purpose, the renderer 300 must be able to output the R/G/B field stream.

Here, one R/G/B field stream shown in FIG. 5 includes a plurality of fields. For example, one R/G/B field stream may include a red field, a green field, and a blue field. The R/G/B field stream having the red field, green field, and blue field has R/G/B information for one frame.

The preprocessing engine 514 preprocesses the information of one or multiple frames provided through the interface 512. Here, during the preprocessing, the provided information of the frame may be decompressed or bypassed. The decompression and bypass may be all performed by the preprocessing engine 514, or at least one or two of the decompression and bypass may be performed by the preprocessing engine 514.

The field buffer 511″ stores the received information of the frame. When the received information of the frame is the R/G/B field stream shown in FIG. 5, the field buffer 511″ stores a first field (R field) which is received first in one R/G/B field stream, and then receives and stores a second field (G field), together with the output of the stored first field. Therefore, since it is enough as long as the field buffer 511″ shown in FIG. 8 can store one field in the information of one frame, the field buffer 511″ can be implemented by a memory having a size smaller than that of the memory of the frame buffer 511 shown in FIG. 6. For example, the memory size of the field buffer 511″ may be ⅓ as large as the memory size of the frame butter 511 shown in FIG. 6. As such, since the memory size of the field buffer 511″ can be reduced, there is an advantage that the memory size of the display controller can be reduced.

The refresher 513′ can increase a frame rate. For example, the refresher 513′ can increase the frame rate to a frame rate (120 Hz to 180 Hz) higher than the frame rate (60 Hz) of the frame that is input through the interface 512. A method for increasing the frame rate is to generate and insert an intermediate frame between the frames received earlier and later by frame rate up conversion. By increasing the frame rate, the MTP latency can be further reduced.

When the display panel 550 is a sequential display panel which scans R, G, and B respectively, the refresher 513′ may re-adjust the pixel position of each of the first field (R field), the second field (G field), and the third field (B field) which are displayed on the display panel 550, on the basis of pixel shift information from the dynamic pixel shifter 518. By the pixel position readjustment of the refresher 513′, it is possible to reduce color breakup of an image being scanned on the screen of the sequential display panel 550 due the motion of the user.

The register 517 receives the time warp control signal from a time warp control module 615 and stores it.

The dynamic pixel shifter 518 generates the pixel shift information on the basis of the time warp control signal stored in the register 517 and provides the generated pixel shift information to the refresher 513′. Here, the pixel shift information may mean that, when a plurality of fields constituting one frame are displayed on the sequential display panel 550, the amount of pixel which should be shifted for each field. Specifically, when each of the first field (R field), the second field (G field), and the third field (B field) which constitute one frame is displayed on the screen of the sequential display panel 550, the pixel shift information may be information for shifting each field by as much as predetermined pixels on the basis of the motion of the user. While, in the past, the display driver IC of the display unit including the sequential display panel had to receive and convert the R/G/B bit packed pixel stream into the R/G/B field stream, the display unit 500″ according to further another embodiment of the present invention shown in FIG. 8 receives directly the R/G/B field stream from the renderer and provides the R/G/B field stream to the display panel 550 that is the sequential display panel. Therefore, the MTP latency can be educed and color breakup of an image can be reduced.

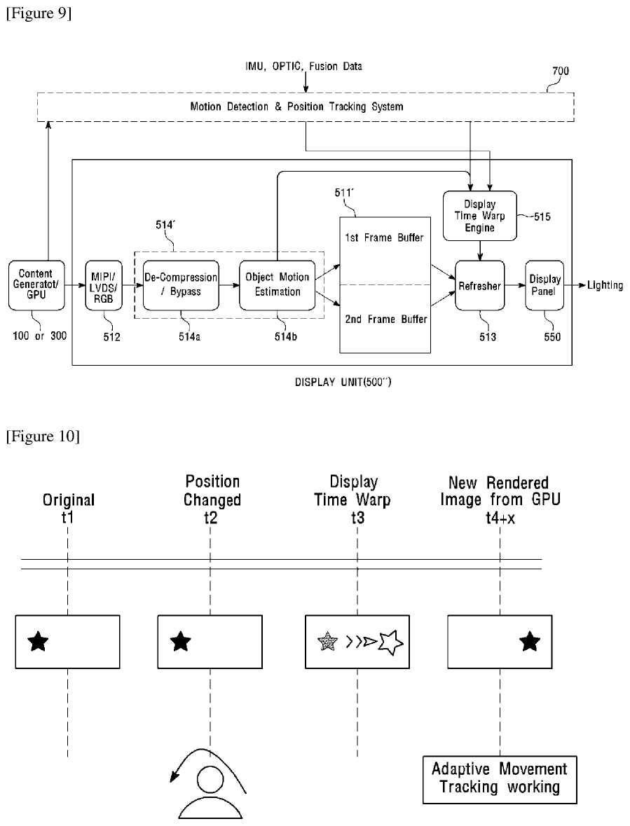

FIG. 9 is a view for describing a display unit 500″ and AR/VR/MR systems including the display unit according to yet another embodiment of the present invention.

Referring to FIG. 9, the display unit 500″ may include the interface 512, a preprocessing engine 514′, the frame buffer 511′, the refresher 513, the display time warp engine 515, and the display panel 550. Since the above components other than the preprocessing engine 514′ have been already described in FIGS. 6 and 7, detailed descriptions thereof will be omitted.

The preprocessing engine 514′ is a specific example of the preprocessing engine 514 shown in FIG. 7. The preprocessing engine 514′ includes a decompression/bypass part 514a and an object motion estimation part 514b.

The decompression/bypass part 514a checks whether the data of the frame provided through the interface 512 is compressed or not. If the data has been compressed, the decompression/bypass part 514a decompresses the data and provides the decompressed data of the frame to the object motion estimation part 514b. Conversely, if the data has not been compressed, the decompression/bypass part 514a provides the received data of the frame to the object motion estimation part 514b.

The object motion estimation part 514b compares the data of two frames received earlier and later and estimates which position in the second frame of the two frames a particular pixel of the first frame of the two frames has moved to.

The object motion estimation part 514b provides information on the estimation to the display time warp engine 515. The display time warp engine 515 determines whether to time-warp the frame on the basis of the provided estimation information.

The display unit 500″ according to the embodiment of the present invention re-adjusts the pixel position within the display unit 500″. Therefore, when the rendered frame is later transmitted from the renderer 300, there is a need to return the pixel which has already been moved in itself to its original position and to synchronize with the transmitted frame. In order to meet the necessity, the display time warp engine 515 determines whether to time-warp the frame on the basis of the estimation information of the object motion estimation part 514b.

Also, the display time warp engine 515 may receive frame update information from the content generator 100 or the renderer 300 through the motion detection and position tracking system 700, and the display time warp engine 515 may determine whether to time-warp the frame on the basis of the received frame update information.

As such, on the basis of the estimation information provided to the object motion estimation part 514b or the frame update information provided from the content generator 100 or the renderer 300, the display time warp engine 515 may determine whether to time-warp the frame which should be time-warped. Here, the display time warp engine 515 may be provided with the two kinds of information, i.e., both the estimation information and the frame update information and determine whether to time-warp the frame.

FIG. 10 shows recognition of a user who wears the display unit 500″ according to still another embodiment of the present invention when the display unit 500″ and the AR/VR/MR systems including the display unit 500″ according to the further another embodiment of the present invention shown in FIG. 9 are applied.

Referring to FIGS. 9 and 10, when the user recognizes at a first time point t1 a frame displayed on the screen of the display panel 550 and the user turns his/her head or body to the left at a predetermined angle at a second tune point t2, the motion detection and position tracking system 700 senses the user's turning and provides the sensed sensing information to the display time warp engine 515. At a third time point t3, the time-warped frame is displayed on the screen of the display panel 550.

In a case where the renderer 300 renders a new frame (or image) at a fourth time point t4 and the rendered new frame is provided as it is to the display unit 500″, the display time warp engine 515 does not time-warp the new frame the same as the earlier frame and checks a difference between the earlier frame and the new frame on the basis of the estimation information to be provided to the object motion estimation part 514b or/and on the basis of the frame update information that is provided from the content generator 100 or the renderer 300. On the basis of the checked result, the display time warp engine 515 can synchronize the new frame without time-warping the new frame. If the display time warp engine 515 time-warps the new trams the same as the earlier frame, an asterisk of the new frame may be further moved to the right.

The features, structures and effects and the like described in the embodiments are included in an embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although the embodiments of the present invention were described above, these are just examples and do not limit the present invention. Further, the present invention may be changed and modified in various ways, without departing from the essential features of the present invention, by those skilled in the art. That is, the components described in detail in the embodiments of the present invention may be modified. Further, differences due to the modification and application should be construed as being included in the scope and spirit of the present invention, which is described in the accompanying claims.

What is claimed is:

1. A display unit for AR/VR/MR systems, the display unit comprising:
a display controller which comprises a frame buffer which stores a rendered frame received from a renderer, a display time warp engine which outputs a time warp control signal on the basis of sensing information received from a motion detection and position tracking system, and a refresher which reads the frame stored in the frame buffer and time-warps the frame on the basis of the time warp control signal; and
a display panel which is provided with the time-warped frame by the refresher and displays the frame on a screen thereof.

2. The display unit for AR/VR/MR systems of claim 1, wherein the time warp control signal comprises movement information of each pixel of the frame stored in the frame buffer.

3. The display unit for AR/VR/MR systems of claim 1, wherein the refresher refreshes the frame buffer periodically.

4. The display unit for AR/VR/MR systems of claim 1, wherein, when the display panel is a sequential display panel which scans R, G, and B respectively, the refresher re-adjusts a pixel position of each of an R field, a G field, and a B field which are transmitted to the display panel, on the basis of the time warp control signal from the display warp engine.

5. The display unit for AR/VR/MR systems of claim 1, wherein the display controller further comprises:
an interface which receives the rendered frame from the renderer; and
a preprocessing engine which preprocesses the rendered frame output from the interface and provides the frame to the frame buffer, and provides preprocessing information to the display time warp engine.

6. The display unit for AR/VR/MR systems of claim 5, wherein the frame buffer is a double frame buffer.

7. The display unit for AR/VR/MR systems of claim 1, wherein the display controller comprises:
an interface which receives sequentially two or more of the rendered frames from the renderer; and
an object motion estimation part which, in a first frame and a second frame which have been received earlier and later from the interface, estimates which position in the second frame each pixel of the first frame has moved to, and provides information on the estimation to the display time warp engine,
wherein the display time warp engine determines whether to time-warp the frame on the basis of the estimation information and the sensing information.

8. The display unit for AR/VR/MR systems of claim 7, wherein the display controller further comprises a decompression/bypass part which decompresses or bypasses the rendered frame received from the renderer.

9. The display unit for AR/VR/MR systems of claim 7,
wherein the display time warp engine receives, from the renderer or a content generator, a frame update information on comparison of the frames received earlier and later,
and wherein the display time warp engine determines whether to time-warp the frame on the basis of the estimation information, the frame update information, and the sensing information.

10. The display unit for AR/VR/MR systems of claim 1,
wherein the display time warp engine receives, from the renderer or a content generator, a frame update information on comparison of the frames received earlier and later,
and wherein the display time warp engine determines whether to time-warp the frame on the basis of the frame update information and the sensing information.

11. A display unit for AR/VR/MR systems comprising:
a display controller comprising a field buffer which receives a plurality of fields constituting each frame from a renderer and stores and sequentially outputs respective fields, a register which stores a time warp control signal from a time warp control module, a dynamic pixel shifter which generates pixel shift information on the basis of the time warp control signal stored in the register, and a refresher which re-adjusts pixel positions of the respective fields stored in the field buffer, on the basis of the pixel shift information generated by the dynamic pixel shifter; and
a sequential display panel which receives sequentially the respective fields re-adjusted by the refresher and displays on a screen thereof.

12. The display unit for AR/VR/MR systems of claim 11, wherein the display controller further comprises:
an interface which receives the frame from the renderer; and
a preprocessing engine which preprocesses the rendered frame output from the interface and provides the frame to the frame buffer.

13. The display unit for AR/VR/MR systems of claim 11, wherein the field buffer receives and stores one of the plurality of fields and not only outputs the stored one field to the refresher but also receives and stores another field.
